(19) United States
(12) Patent Application Publication
(10) Pub. No.: US 2012/0128448 A1
(43) Pub. Date: May 24, 2012

(54) LIFTING DEVICE WITH DISTRIBUTED-SENSING SCALE

(75) Inventors: Thomas ALLGEIER, Cardiff (GB); Michael Phillips, Bridgend (GB)

(73) Assignee: FLINTEC UK LIMITED, Cardiff (GB)

(21) Appl. No.: 13/300,682

(22) Filed: Nov. 21, 2011

(30) Foreign Application Priority Data
Nov. 23, 2010 (GB) 1019778.8

(51) Int. Cl. B66F 5/04; B65G 69/00; A61G 7/14

(52) U.S. Cl. 414/21

(57) ABSTRACT

A lifting device comprises a support element and an actuator for pivotably moving a lifting arm. A load cell outputs a load signal from the actuator. A first torque sensor outputs a first torque signal from at least one of a pivot between the lifting arm and the support element and along the lifting arm. A second torque sensor outputs a second torque signal from at least one of the pivot between the actuator and the support element, the pivot between the actuator and the lifting arm and along the actuator. A displacement sensor outputs a displacement signal from the actuator, and a calculator calculates a weight at a distal end of the lifting arm based on the distributed load signal, first and second torque signals, and the displacement signal.

This application claims priority to GB Patent Application No. 1019778.8 filed on Nov. 23, 2010, the disclosure of which is incorporated herein by reference in its entirety.

### BACKGROUND OF THE INVENTION

1. Field of the Invention

The present invention relates to a lifting device with a distributed-sensing scale, and more particularly but not necessarily exclusively to an invalid hoist having such a scale.

2. Description of the Prior Art

Lifting devices and in particular hoists are well known and used in many different fields, from automotive to patient care. These lifting devices are frequently freestanding and fully mobile, but may be static, fixed or ceiling/wall mounted.

It is known to include a single weighing device in the lifting arm of a hoist, incorporated in a hanger at the end of the lifting arm, or as part of a spreader bar to which a patient sling can be attached. However, in the case of the weighing device being on the lifting arm, this has proved to lack accuracy due to bending or tilting of other parts of the hoist during loading; a weighing device being on a hanger undesirably increases the drop and thus the ground clearance of the hoist; and many varieties of spreader bar are available which may suit different patients, but not all include weighing means resulting in decreased functionality in some circumstances.

The present invention seeks to provide a solution to these problems.

### SUMMARY OF THE INVENTION

According to the present invention, there is provided A lifting device comprising a support element, a lifting arm which is pivotably connected to the support element, an actuator which is pivotably connected to the lifting arm and the support element and which raises and lowers the lifting arm, a load cell which outputs a load signal corresponding to a load imparted to the actuator, a first torque sensor which outputs a first torque signal corresponding to a first torque imparted at at least one of the pivot between the lifting arm and the support element and along the lifting arm, a second torque sensor which outputs a second torque signal corresponding to a second torque imparted at at least one of the pivot between the actuator and the support element, the pivot between the actuator and the lifting arm and along the actuator, a displacement sensor which outputs a displacement signal corresponding to a displacement of the actuator, and a calculator which calculates a weight at a distal end of the lifting arm based on the load signal, first and second torque signals, and the displacement signal.

The invention will now be more particularly described, by way of example only, with reference to the accompanying drawings.

### BRIEF DESCRIPTION OF THE DRAWINGS

FIG. 1 shows a perspective view of a lifting device, in accordance with the present invention;

FIG. 2 shows a diagrammatic side elevational view of the lifting device of FIG. 1; and

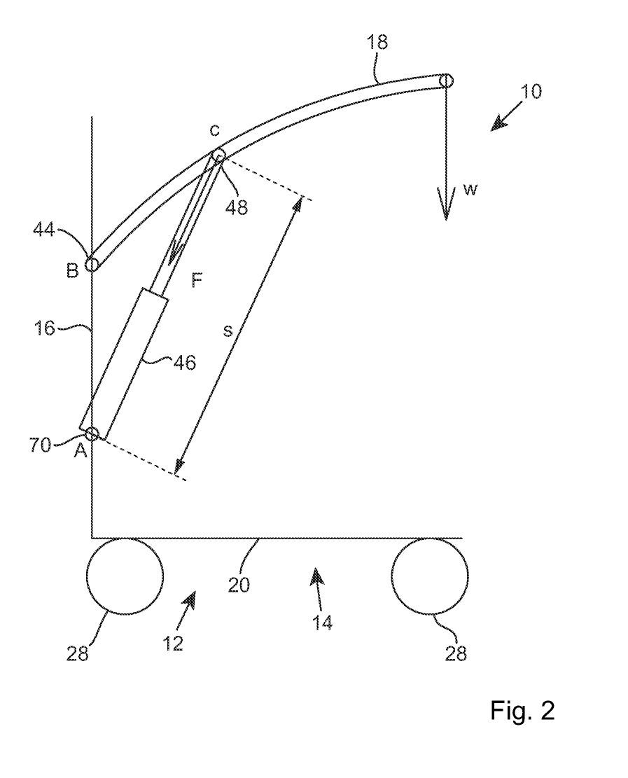

FIG. 3 represents the geometry of the lifting device used during the static analysis by which the weight of the imparted load can be determined.

### DETAILED DESCRIPTION OF THE PREFERRED EMBODIMENT

Referring to the drawings, there is shown a lifting device 10, in this case being a patient hoist 12, which comprises a chassis 14, a mast element 16 upstanding from the chassis 14, and a lifting arm 18 supported by the mast element 16.

The chassis 14 includes two legs 20 and a cross-member 22 connected between the two legs 20 at or substantially at proximal ends 24 thereof. The legs 20 may be pivotable at or adjacent to the cross-member 22 so that they can be moved from a position in which they are parallel or substantially parallel to each other to a position in which they are splayed apart. When splayed, the legs 20 diverge in a direction towards their distal ends 26. This enables, for example, a chair to be accommodated between the splayed legs 20.

The pivoting of the legs 20 may be motorised, for example by an electric motor being provided in the cross-member 22, or manual.

The distal end 26 of each leg 20 is provided with a castor 28, and two spaced apart outriggers 30 extend oppositely to the legs 20 from the cross-member 22. Each outrigger 30 includes a further castor 32 at its distal end 34.

The mast element 16 upstands from the cross-member 22. In this embodiment, the mast element 16 includes two mast members 36 which are spaced apart at their lower ends 38 and which are interconnected at their upper ends 40. The lower ends 38 of the mast members 36 are supported by the cross-member 22 at or adjacent to side edges of the cross-member 22, thereby improving lateral stability.

The mast members 36 are aligned so as to be in parallel with each other, but are non-planer. In this case, each mast member 36 is at least in part arcuate, defining substantially a swan-neck profile.

In this case, the mast element 16 is fixed. However, the mast element may be height-adjustable, and typically this would be via a telescopic adjustment mechanism.

A proximal end 42 of the lifting arm 18 is pivotably connected to the mast element 16 at a first pivot 44 at the interconnected upper ends 40 of the mast members 36. The lifting arm 18 is raised and lowered by telescopic extension and retraction of a lifting arm actuator 46 which is pivotably connected to the lifting arm 18 at a second pivot 48 partway between the proximal and distal ends 42, 50. The second pivot 48 is preferably closer to the proximal end 42 of the lifting arm 18 than the distal end 50.

The lifting arm 18 has, in this case, a non-planer longitudinal extent. The longitudinal extent is smoothly and continuously arcuate or curved from the distal end 50 to the proximal end 42. However, it may include one or more rectilinear portions, as necessity dictates.

The free distal end 50 of the lifting arm 18 is provided with a spreader bar attachment 52 in the form of a spindle pivotable about a rigid vertical or substantially vertical axis.

A spreader bar 54 comprises a sling hanger 56 and a sling hanger support 58. The sling hanger support 58 which is of generally inverted U-shaped configuration is attached to the spindle, and the sling hanger 56 which is of generally Y-shaped configuration is connected to the lower ends of the two arms of the sling hanger support 58 so as to be pivotable about a generally horizontal axis. The sling hanger 56 has studs or connectors 60 for releasable attachment of a patient support sling, which is typically a full body support sling.

In this embodiment, a spreader bar actuator 62 is provided to provide powered control of the sling hanger 56. The spreader bar actuator 62 is mounted on one side of the sling hanger support 58 and extends to a point on the sling hanger 56 which is adjacent to the pivot between the sling hanger support 58 and the sling hanger 56. The spreader bar actuator 62 is preferably battery powered and controlled by an associated user-controller.

The lifting arm actuator 46 includes an actuator housing 64 in or on which is receivable a rechargeable battery pack 65, and which includes a user-operable lifting arm controller 66. The lifting arm controller 66 is typically also a remotely operable device thereby allowing a carer the greatest degree of freedom and control.

A lower end 68 of the actuator 46 is pivotably mounted at a third pivot 70 to a cross-bar 72 extending substantially horizontally between the mast members 36 partway along their longitudinal extents. Typically, the actuator housing 64 extends around the third pivot 70 and at least a majority of the cross-bar 72.

A telescopic ram 74 of the actuator 46 extends from an upper end 76 of the actuator housing 64 to the second pivot 48.

The first pivot 44 incorporates a first torque sensor 78 for outputting a first torque signal indicative of a torque imparted between the lifting arm 18 and the mast element 16 at the first pivot 44. The first torque sensor 78 beneficially includes at least one strain gauge mounted on at least one flexure strip element which interconnects the lifting arm 18 and the mast member 36.

Conveniently two flexure strip elements arranged at right angles are used.

Although preferably at the first pivot 44, it may be beneficial to include a supplementary first torque sensor along the lifting arm 18 to measure a torque or bending moment imparted during use. The first torque sensor 78 may be dispensed with in favour of the supplementary first torque sensor.

The third pivot 70 incorporates a second torque sensor 80 for outputting a second torque signal indicative of a torque imparted between the lifting arm actuator 46 and the cross-bar 72 of the mast element 16 at the second pivot 48. The second torque sensor 80 again beneficially includes at least one strain gauge mounted on at least one flexure strip element which interconnects the lifting arm actuator 46 and the cross-bar 72.

Although preferably at the third pivot 70, it may be beneficial to include a supplementary second torque sensor along the lifting arm actuator 46 to measure a torque or bending moment imparted during use. As before, the second torque sensor 80 may be dispensed with in favour of the supplementary second torque sensor.

Although preferably provided at the third pivot 70 in this embodiment, the second torque sensor 80 or a further second torque sensor can be provided at the second pivot 48 in the manner as described above.

The lifting arm actuator 46 also includes a load cell 82 for outputting a load signal corresponding to a load imparted to the lifting arm actuator 46, typically being via the lifting arm 18 once a patient is lifted.

The load cell 82 may conveniently be of an S-shaped bending beam configuration, and is preferably on the lifting arm actuator 46 adjacent to the third pivot 70. Beneficially, the load cell 82 may be coupled with the second torque sensor 80 arrangement in piggy-backed fashion, thereby providing a compact unit for measuring load and torque at or adjacent to a single point.

Alternatively the second torque sensor 80 and the load cell 82 can be combined into a single integral multi-component transducer.

The or a said load cell 82 may additionally or alternatively be utilised at or adjacent to the second pivot 48, or along the lifting arm actuator 46.

Conveniently, the load cell 82 may be in the form of a shear pin load cell which could thus be accommodated within the second and/or third pivots 48, 70.

The lifting arm actuator 46 also includes a displacement sensor 84, such as a shaft encoder, for outputting a displacement signal corresponding to a linear displacement of the lifting arm actuator 46. Preferably, this is incorporated within or on the telescopic ram 74 of the lifting arm actuator 46, but may additionally or alternatively be within the actuator housing 64.

Although linear displacement is preferably monitored, the displacement could be angular, for example if the extension and retraction of the ram is screwed rotation.

Output signals of the first torque sensor 78, supplementary first torque sensor if provided, second torque sensor 80, supplementary second torque sensor if provided, load cell 82 and displacement sensor 84 are inputted to a calculation unit 86 having processing circuitry 88, preferably provided within the actuator housing 64.

It has been determined that there is a determinable relationship between a weight applied to the sling hanger 56 at the end of the lifting arm 18, the extension of the lifting arm actuator 46, and the force acting in the ram 74 of the lifting arm actuator 46 to support the lifting arm 18.

It has also been determined that detrimental influences resulting from friction at pivots 44, 48, 70 between the lifting arm 18 and the mast member 36, the lifting arm actuator 46 and the lifting arm 18, and the lifting arm actuator 46 and the mast member 36, as well as within the lifting arm actuator 46 itself, for example, in bearings, impact the accuracy of the measured load.

Consequently, if these frictional forces, and in particular torques at the pivots 44, 48, 70 or along the lifting arm length and actuator length can be largely accounted for, a far more accurate weight measurement at the distal end 50 of the lifting arm 18 can be determined.

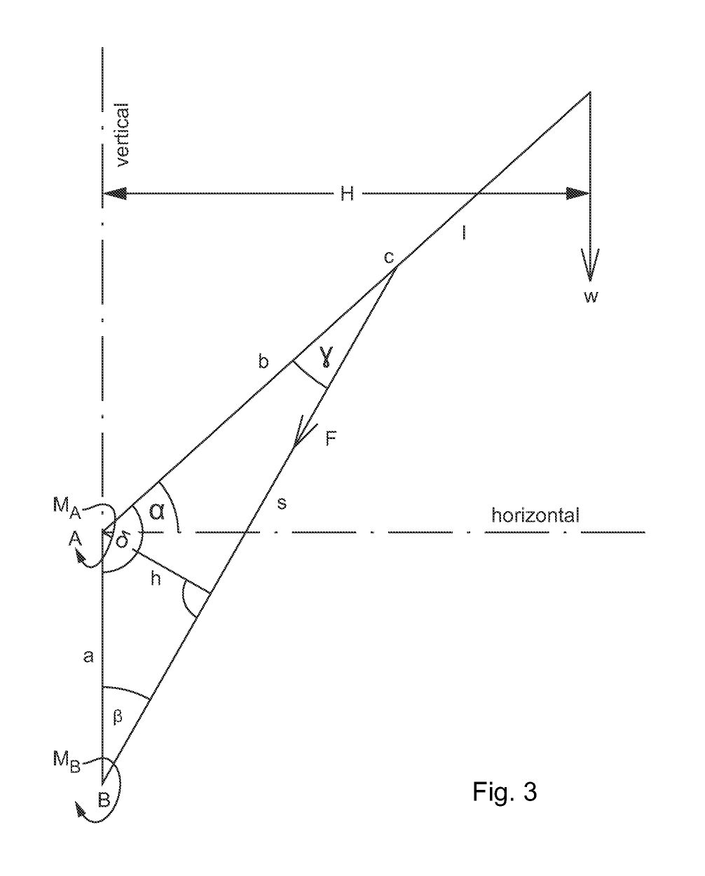

Referring now to FIG. 3, the static analysis is described. The patient weight force W is balanced by the lifting arm actuator force F and the ‘parasitic’ torque M_{A} at the second pivot A and M_{B} at the first pivot B, which are distributed around the lifting device structure and thus spaced apart. If all three are measured, the variable lifting arm actuator length s is known, along with remaining geometry of the lifting device then the weight W at the distal end of the lifting arm can be calculated.

Moments are taken around the second pivot B as follows:

1) W*H=F*h+M_{A}+M_{B}
Where h is horizontal distance from the first pivot A to the actuator. Therefore:

2) W=(F*h+M_{A}+M_{B})/H

With F, M_{A} and M_{B} measured by the respective load cell, second torque sensor and the first torque sensor, h and H can be calculated from the geometric quantities. This reduces to finding the angle α and the 3 angles β, γ and δ of the triangle ABC.

In the triangle ABC, the length of all three sides a, b, s is known, since s being a variable is determined by the displacement sensor on the lifting actuator.

From this:

3) s²=a²+b²−*a*b* cos δ

Therefore:

4) cos δ=(a²+b²s²)/(2*a*b)

Which follows that:

5) α=δ−90°

β, γ can now be calculated:

6) sin²δ=1−cos² δ

7) sin²δ=√(1−cos² δ)

8) a/sin γ=b/sin β=s/√(1−cos² δ)=s/√(1−((a²+b²s²)/(2*a*b))²)

9) sin γ=(a√(1−((a²+b²−s²)/(2*a*b))²))/s

10) sin β=(b√(1−((a²+b²−s²)/(2*a*b))²))/s=h/a

11) h=(a*b √(1−((a²+b²−s²)/(2*a*b))²))/s

12) cos α=H/1

13) H=1* cos α

This provides all the quantities for the processing circuit of the calculation unit to utilise in equation 2) as follows:

14) W=(F*((a*b√(1−((a²+b²s²)/(2*a*b))²))/s)+M_{A}+M_{B})/(1* cos ((cos¹((a²b²s²)/(2*a*b))−90⁰))

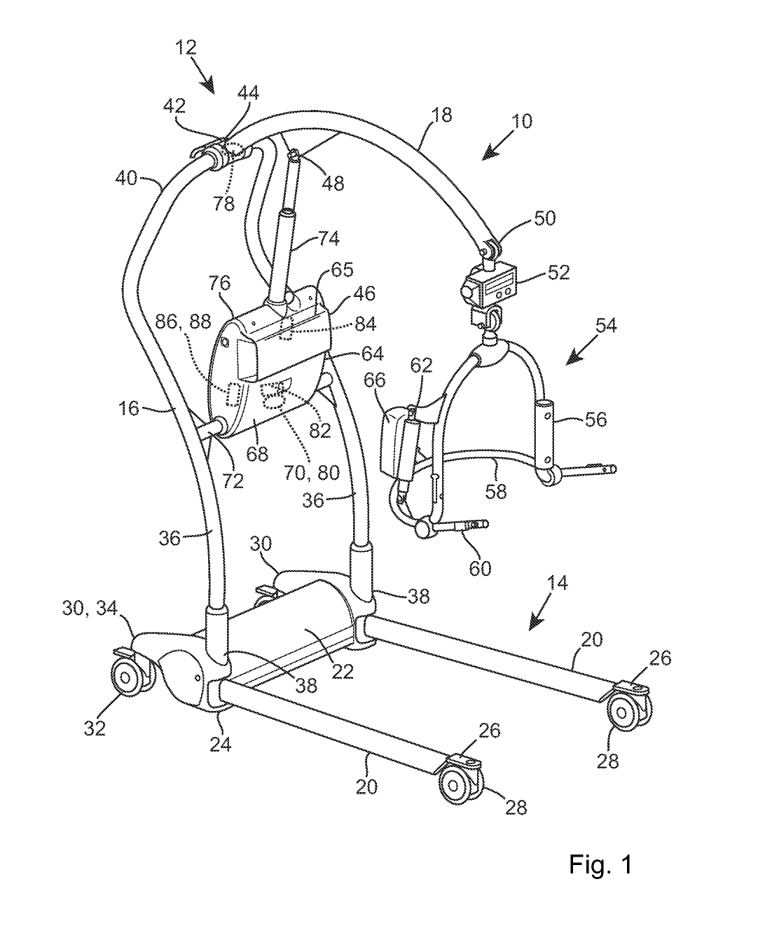

By way of example and based on the lifting device shown in FIG. 1, the input values are substantially as follows:
a=700 mm
b=241 mm
l=901 mm
s=605-905 mm

This leads to a load F of 6500N for a weight W of 2000N for the lifting arm actuator withdrawn, and nearly 10000N for the lifting arm actuator extended at the same weight W.

The influence of the parasitic moments can be estimated easily by calculation: Assuming M_{A} and M_{B} are both 10 Nm, the 2000N weight value is affected by 22N, or about 2%.

For the same conditions, a_lifting arm actuator length change of 1 mm produces a weight change of 3.3N.

It can therefore be deduced that at least a 1000 kg (10 kN) load cell in the lifting arm actuator is required.

The influence of the parasitic torques is small, and typically the torques are likely to be small also. Assuming that the 10 Nm is typical, a torque uncertainty of 1 Nm would be equivalent to a 0.1 % error. It is possible to achieve this uncertainty or better with a 10 Nm sensor.

Since there is a trade-off between capacity and accuracy, the magnitudes of the torques likely to be encountered in various different lifting devices must be recognised so that suitable transducers, being the load cell and torque sensors, can be utilised in the specific lifting device.

It has been noted that the lifting arm actuator length sensitivity is high. As such, an accuracy of at least 0.1 mm from the actuator is required, however the displacement signal generated by conventionally known means will be able to achieve this.

It is also recognised that elastic deformation of the structure of the lifting device should also be evaluated, and in all likelihood a degree of correction should be applied to the calculations by the processing circuit.

Although the lifting device described above is a freestanding mobile patient or invalid hoist, any lifting device can incorporate the distributed-sensing scale as outlined. The invalid hoist enables weighing of a patient suspended from the lifting arm, but the distributed-sensing scale is applicable to fixed or wall/ceiling mounted hoists if torques and/or bending moments are imparted during use. The lifting device may be a hoist or crane within different fields, such as construction or automotive, as well as in the medical and patient care fields.

The embodiments described above are provided by way of examples only, and various other modifications will be apparent to persons skilled in the field without departing from the scope of the invention as defined by the appended claims.

What is claimed is:

1. A lifting device comprising a support element, a lifting arm which is pivotably connected to the support element, an actuator which is pivotably connected to the lifting arm and the support element and which raises and lowers the lifting arm, a load cell which outputs a load signal corresponding to a load imparted to the actuator, a first torque sensor which outputs a first torque signal corresponding to a first torque imparted at at least one of the pivot between the lifting arm and the support element and along the lifting arm, a second torque sensor which outputs a second torque signal corresponding to a second torque imparted at at least one of the pivot between the actuator and the support element, the pivot between the actuator and the lifting arm and along the actuator, a displacement sensor which outputs a displacement signal corresponding to a displacement of the actuator, and a calculator which calculates a weight at a distal end of the lifting arm based on the load signal, first and second torque signals, and the displacement signal.

2. A lifting device as claimed in claim 1, wherein the load cell is on the actuator.

3. A lifting device as claimed in claim 2, wherein the load cell is at or adjacent to the pivot between the actuator and the support element.

4. A lifting device as claimed in claim 2, wherein the load cell is at or adjacent to the pivot between the actuator and the lifting arm.

5. A lifting device as claimed in claim 1, wherein the load cell and the second torque sensor are provided together.

6. A lifting device as claimed in claim 1, wherein the load cell and the second torque sensor are provided at or adjacent to opposite ends of the actuator.

7. A lifting device as claimed in claim 1, wherein the load cell is a load pin provided at at least one of the pivot between the actuator and the support element and the pivot between the actuator and the lifting arm.

8. A lifting device as claimed in claim 1, wherein the first torque sensor is in the pivot between the lifting arm and the support element.

9. A lifting device as claimed in claim 1, wherein the first torque sensor is on the lifting arm.

10. A lifting device as claimed in claim 1, wherein the second torque sensor is in the pivot between the actuator and the support element.

11. A lifting device as claimed in claim 1, wherein the second torque sensor is in the pivot between the actuator and the lifting arm.

12. A lifting device as claimed in claim 1, wherein the second torque sensor is on the actuator.

13. A lifting device as claimed in claim 1, wherein the displacement sensor is on the actuator.

14. A lifting device as claimed in claim 1, wherein the displacement sensor outputs a displacement signal corresponding to a linear displacement of the actuator.

15. A lifting device as claimed in claim 1, wherein the support element includes a chassis, a plurality of wheels on the chassis, and a mast element which upstands from the chassis, the chassis including two elongate legs which extend forwardly of the mast element, the legs being angularly and/or length adjustable.

16. A lifting device as claimed in claim 15, wherein the mast element is height-adjustable.

17. A lifting device as claimed in claim 15, wherein the mast element includes two spaced apart elongate mast members which extend upwardly from the chassis.

18. A lifting device as claimed in claim 17, wherein longitudinal extents of the mast members are non-planer.

19. A lifting device as claimed in claim 1, wherein a longitudinal extent of the lifting arm is non-planer.

20. A lifting device as claimed in claim 1, wherein the actuator is pivotably connected to the lifting arm between its proximal and distal ends.
